(19) United States
(12) Patent Application Publication
(10) Pub. No.: US 2013/0127119 A1
(43) Pub. Date: May 23, 2013

(54) SEALING ASSEMBLY FOR ROLLING BEARINGS

(71) Applicants: Alexander Haepp, Hofheim (DE); Wilhelm Walter, Hambach (DE)

(72) Inventors: Alexander Haepp, Hofheim (DE); Wilhelm Walter, Hambach (DE)

(73) Assignee: Schaeffler Technologies AG & Co. KG, Herzogenaurach (DE)

(21) Appl. No.: 13/814,627

(22) PCT Filed: May 31, 2011
(86) PCT No.: PCT/EP2011/058883

§ 371 Date: Feb. 6, 2013

(30) Foreign Application Priority Data
Aug. 13, 2010 (DE) 10 2010 034 385.4

(51) Int. Cl. F16C 33/80

(52) U.S. Cl. CPC F16C 33/805
USPC 277/351; 277/572

(57) ABSTRACT

A sealing assembly for sealing a rolling bearing, between a first and a second bearing part, where the two bearing parts are rotatable relative to each other and form therebetween both an axial space and a radial space. The sealing assembly includes: A contact member having a mounting section for attachment and a ring-shaped contact section for positioning the contact member on the second bearing part, and a carrier mountable to the first bearing part and has an elastic member forming a first axial sealing lip and/or a radial sealing lip. The contact member and a radially extending portion of the second bearing part together form a first collecting channel, and that an opening leading into the first collecting channel should be at least partially defined by an end section of the contact member.

The present invention relates to a sealing assembly for sealing a rolling bearing, in particular a wheel bearing, between a first and a second bearing part, where the two bearing parts are rotatable relative to each other and form therebetween both an axial space and a radial space with respect to a common axis of rotation. The sealing assembly includes the following:
a contact member having a preferably hollow-cylindrical mounting section for attachment and a ring-shaped contact section for positioning the contact member on the second bearing part,
carrier which can be mounted to the first bearing part and has an elastic member forming a first axial sealing lip and/or a radial sealing lip.

### BACKGROUND

Sealing assemblies where sliding sealing contacts are provided by axial and radial sealing lips are typically used for sealing a rolling bearing. The two bearing parts to be sealed may face each other both radially and axially. Such a situation is often found in mechanical engineering, such as in machine tools, shafts, or also in wheel bearings for passenger vehicles or trucks.

Japanese Patent Publication JP 2003-56577 describes a wheel bearing where a seal is to be established between the outer ring, as a first bearing part, and the wheel flange, as a second bearing part. To this end, a metal contact plate is provided which contacts the wheel hub, respectively the wheel flange, both radially and axially, and on which sliding sealing contacts are provided by an axial sealing lip and a radial sealing lip, the sealing lips being carried by a carrier attached to a radially inner surface of the outer ring.

The prior art sealing assembly has the disadvantage that environmental influences can act directly on a sealing lip from outside, whereby the sealing lip material, mostly an elastomer, becomes worn very quickly. In the case of ingress of foreign bodies, such as sand and water, for example, a grinding effect is produced which wears away the sealing lip, cuts grooves into the raceway, and thereby reduces the preload of sealing lip.

### SUMMARY OF THE INVENTION

It is an object of the present invention to provide a cost-effective approach for increasing the service life and the sealing performance of a sealing-lip-based sealing assembly without degrading the known characteristics of conventional sealing assemblies.

The present invention provides a sealing assembly of the above-mentioned type in that the contact member is adapted to form, together with a radially extending portion of the second bearing part, a first collecting channel, and in that an opening leading into the first collecting channel is at least partially defined by an end section of the contact member.

The opening leads into the first collecting channel, thereby preventing any foreign matter and the water itself from entering the sealing assembly during centrifugal throw-off processes or during water run-off. For this reason, the opening is oriented substantially in the axial direction and, moreover, is located axially opposite the second bearing part, which may be a wheel flange, for example. The opening is radially spaced so far from the bottom of the collecting channel that water and dirt particles can be received in the collecting channel and carried away in the circumferential direction.

The opening forms the beginning of a labyrinth seal which is designed as a non-contact pre-seal and protects sealing lips downstream of the labyrinth seal from environmental influences. Thus, the labyrinth seal extends from the opening to the first sliding sealing contact and is formed by different parts of the sealing assembly, including, inter alia, the contact member.

The two bearing parts, which are rotatable relative to each other, may be, for example, a stationary outer ring and a rotatable inner wheel hub, or an outer ring designed as a wheel hub and supported on an axle journal. In both cases, a radial space and an axial space are formed between the bearing parts.

Preferably, the contact member has a hollow-cylindrical mounting section for attachment and a ring-shaped contact section for positioning the contact member on the second bearing part. This allows the contact member to be attached more easily, namely by sliding it by the hollow-cylindrical mounting section onto the second bearing part until it abuts or engages a radially extending portion of the second bearing part, The mounting section should be attached by a press fit in order to prevent later changes in the axial position. Such changes would have an adverse effect because the contact section would no longer engage the second bearing part, and thus dirt particles could reach the mounting section. This would increase the probability of corrosion occurring under the mounting section of the contact member.

The carrier, which can be mounted to the first bearing part, carries an elastic member forming a first axial sealing lip and/or a radial sealing lip. The radial sealing lip and/or at least the axial sealing lip engage(s) the contact member, making sliding, sealing contact therewith at the respective locations. Advantageously, the contact member can be composed of a material which is resistant even under sealing contact conditions (e.g., non-corroding materials). As an alternative, two axial sealing lips may be provided in place of a radial sealing lip.

The first collecting channel is formed by the radially extending portion of the second bearing part and the radially outer portion of the contact member. To this end, the outer portion may have a cylindrical section which merges into an end section. The end section should extend substantially radially in order to prevent ingress of water into the opening defined by the end section.

Advantageously, at least one segment of the contact member that forms the first collecting channel forms a part of a labyrinth seal. The outer end section of the contact member is such a segment, but not necessarily the only one. Thus, a dual function is implemented on the contact member, resulting in material savings.

In an advantageous embodiment, a mounting section of the contact member is connected to the contact section of the contact member by a preferably conical connecting section. The connecting section may have different, possibly advantageous shapes. In any case, contacting engagement of the connecting section is not advantageous because this would require the exactly reproduce the shape of the second bearing part in terms of its curvature. In this case, a conical shape is expedient. If the intention is to gain more space for the sealing assembly, for example, for an additional contact face of a sealing lip, it is expedient for the connecting section to have a rounded shape. In order to enhance the seal between the contact member and the second bearing part, the space between the connecting section and the second bearing part may be filled with a sealing compound to prevent moisture from entering the rolling bearing at this point.

In an advantageous embodiment, the contact member is designed to radially encompass the first bearing part, and the first bearing part forms a part of the labyrinth seal. Thus, the first bearing part also contributes in obtaining the seal, thereby allowing for material savings. Furthermore, this embodiment is advantageous for use in rolling bearings which have a particularly small axial space therein.

In an advantageous embodiment, the opening is formed by the end section of the contact member and a cover member which can be mounted on the first bearing part. The opening is ideally as small as possible in terms of its radial dimension in order to prevent ingress of water and dirt. Moreover, it is advantageous for the opening to be annular in shape, such as, for example, an annular gap, because this shape is the least complex to produce.

In an advantageous embodiment, the opening is defined in part by an extension of the elastic member and in part by the end section of the contact member, so that the elastic member and the contact member together form the opening. This provides the advantage of a reduction in the number of component parts. Similar to cartridge seals, a two-part sealing assembly can be obtained with a contact member and a sealing ring, because there is no need for a cover plate on the outer surface of the first bearing part for forming the opening or a labyrinth seal. Instead, this function is performed by the elastic member (e.g. an elastomer).

In an advantageous embodiment, a sealing ring is formed on the elastic member. The sealing ring provides a non-sliding seal for a mounting section of the carrier. In the simplest case, the sealing ring may be configured as an O-ring. The O-ring may be a separate part or may be joined to the elastic member by a material-to-material bond.

The sealing ring on the elastic member forms a so-called “static seal”, since the mounting section of the carrier and the first bearing part do not rotate relative to each other. This does not rule out that the sealing ring may be rotatable together with the first bearing part and the mounting section, such as is the case in particular in commercial vehicle applications, but also in passenger vehicle applications, where the first bearing part is formed by a rotatable outer ring of the wheel hub.

In an advantageous embodiment, the labyrinth seal is at least partially formed by the elastic member and the at least one segment of the contact member that forms the first collecting channel. The labyrinth seal is a gap seal, where the direction of extension of the seal gap changes several times. In other words, a labyrinth seal is formed by a plurality of gaps which are interconnected, but oriented in different directions. The shape of the elastic member and the shape of the contact member are matched such that a labyrinth seal is formed which may have different collecting means, such as a collecting channel.

Advantageously, the elastic member forms a second collecting channel extending radially inwardly from the first collecting channel. This has the advantage that any dirt or water that has or have entered can be collected in the second collecting channel and carried away therein in the circumferential direction, and can exit the labyrinth seal through an annular gap upstream of the second collecting channel and through the subsequent opening. It is also advantageous that the contact member, which forms a part of the first collecting channel, also forms a part of the aforesaid annular gap and may radially cover the second collecting channel.

Advantageously, the extension partly covers the second collecting channel radially. The extension is formed to extend in a substantially axial direction so as to radially cover the annular gap or the second collecting channel. It is also advantageous if the extension also covers end section 34 radially, either partially or entirely. This ensures that the opening is oriented substantially axially.

Advantageously, the extension has a conical or similarly shaped inner surface at the radially outer end of the annular gap, so that any water that has entered can easily exit the labyrinth seal.

In some cases, the extension may form the radially outermost portion of the sealing assembly, in order that water can drip down from this extension and to allow water falling on the sealing assembly from above to be kept away from the first collecting channel.

Further advantageous embodiments and preferred refinements of the invention will become apparent from description of the figures and/or the dependent claims.

### BRIEF DESCRIPTION OF THE DRAWINGS

The invention is described and explained in more detail below with reference to the exemplary embodiments illustrated in the drawings, in which:

FIG. 1 shows a three-part sealing assembly having a cover member; and

FIG. 2 shows a two-part sealing assembly having a multi-functional elastic member.

### DETAILED DESCRIPTION

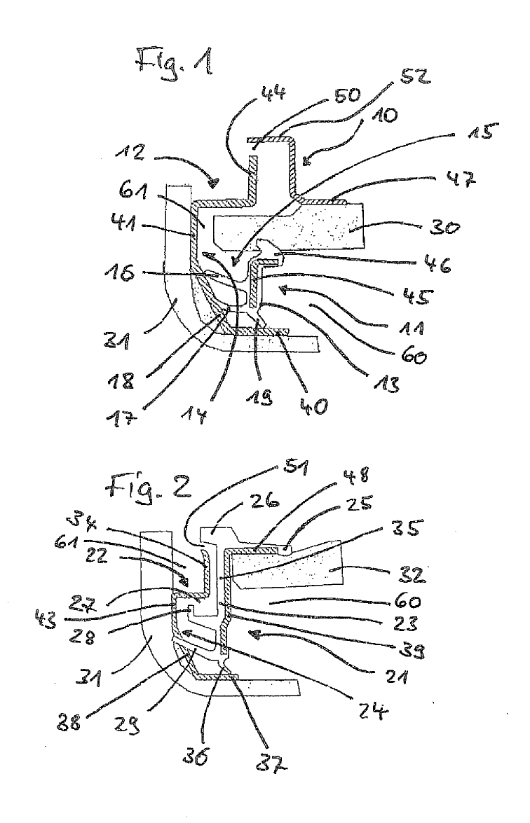

FIG. 1 shows a three-part sealing assembly having a cover member 10. The sealing assembly has a frictionless pre-seal, which is designed as a labyrinth seal and formed by contact member 14, first bearing part 30, and cover member 10. Cover member 10 is cold-formed from sheet metal and has a hollow-cylindrical section 52, at the end of which an annular opening 50 is located which leads into first collecting channel 12 of contact member 14. Alternatively, cover member 10 may be formed from plastic or machined on a lathe. Cover member 10 further has a mounting section 47, which is press-fitted onto an outer surface of first bearing part 30, which is in the form of an outer ring.

The outer ring may form at least a part of a wheel hub 30, so that cover member 10 becomes a kind of a centrifugal throw-off plate from which water comes off radially during rotation and is thereby kept away from opening 50. Water and dirt particles entering stationary first collecting channel 12 are carried away in the circumferential direction and drip off onto the ground surface by gravity in a vertical direction.

Furthermore, first collecting channel 12 covers axial space 61 which, due to the pre-seal, is much less accessible to water and dirt than in conventional sealing assemblies.

Moreover, axial space 61 accommodates at least part of contact member 41, which abuts on second bearing part 31 forming a water-tight seal. In this exemplary embodiment, second bearing part 31 takes the form of a stationary axle journal.

A conical connecting section 18 connects contact section 41 to hollow-cylindrical mounting section 40, which is fixed, in particular in its axial position, by a press fit so as not to jeopardize the water-tight contact of contact section 41. Moreover, connecting section 18 and axial sealing lips 16, 17 together form two sliding sealing contacts, which protect the rolling space of the wheel bearing. All sealing lips 16, 17, 19 are formed on elastic member 13 and may be used alone or in any combination, depending on the sealing action to be achieved. The fewer sealing lips used, the lower the coefficient of friction of the sealing assembly.

Carrier 45 is anchored in an inner recess of first bearing part 30 by an anchor 46 of elastic member 13. Alternatively, carrier 45 may itself be attached by a cylindrical press fit to the inner surface of first bearing part 30. Carrier 45 and elastic member 13 together form sealing ring 11, which can be readily pressed into first bearing part 30. Although the outer radius of anchor 46 is larger than the inner radius of first bearing part 30, pressing-in can be easily accomplished because of the elastic nature of anchor 46.

Radially outer axial sealing lip 16 forms a second collecting channel 15. Water and dirt particles can exit second collecting channel 15 by gravity. In order to support this, hollow-cylindrical portions 52 of cover member 10 and of contact member 14 may be made at least slightly conical on the inner side to facilitate discharge.

FIG. 2 shows a two-part sealing assembly having a multi-functional elastic member 23. Elastic member 23 performs the function of cover member 10 of FIG. 1. For this reason, carrier 39 of elastic member 23 is press-fitted onto an outer surface of first bearing part 32. In order to prevent corrosion from occurring under mounting section 48 of carrier 39, a so-called “static seal” is provided by the integrally formed non-sliding seal 25 in that this seal is substantially ring-shaped and engaged within an outer recess of first bearing part 32.

If the sealing assembly is used in a passenger vehicle application, first bearing part 32 corresponds to a stationary outer ring, and therefore non-sliding seal 25 is also stationary. Thus, second bearing part 31 is a wheel hub having a radially extending portion provided by the wheel flange.

Cover member 24 is attached to second bearing part 31 in the same way as bearing part 41 of FIG. 1, the difference being that cover member 24 is designed to rotate during operation. Thus, end section 34 has a centrifugal throw-off effect, which prevents dirt and water from entering opening 51. For this purpose, end section 34 advantageously forms a separation edge, which may be implemented by a slight bevel on end section 34.

Because opening 51 is oriented axially toward the wheel flange, water flowing in radial directions can be prevented from entering the labyrinth seal. Preferably, extension 26 is shaped such that it has the largest outer diameter of the sealing assembly, so that dirty water can drip down therefrom. It also covers an annular gap leading into second collecting channel 27. The annular shape of the gap ensures that any dirt or water that has or have entered can readily exit the labyrinth seal through opening 51. Second collecting channel 27 may be formed by a non-sliding axial sealing lip, the end of which is directed radially outward and, together with the radially inner bottom of first collecting channel 22, forms a further sealing element of the labyrinth seal in the form of a second annular passage opening.

In order for elastic member 23 to be able to perform so many functions, it extends from the axial end of mounting section 48 to the radially inner end of carrier 39, covering carrier 39 radially outwardly and being disposed axially between contact member 43 and carrier 39. Alternatively, the various functions may also be performed by elastic members to be separately mounted, which, however, results in increased manufacturing complexity and cost.

The sealing assembly includes an axial sealing lip 29 and a radial sealing lip 36 which make sliding sealing contact with contact member 24; i.e., with connecting section 38 and mounting section 37, respectively.

The sealing assembly of FIG. 2 is located outside the radial space 60 defined by first bearing part 32 and second bearing part 31. It is also advantageous that less adaptation is required for first bearing part 32 to allow the use of the bearing assembly. Although not mandatory, it is advantageous to provide an outer recess for non-sliding seal 25. The two-part design also provides advantages during installation of the sealing assembly, because there is no separate cover member.

Sealing ring 21, which includes elastic member 23 and carrier 39, performs not only the normal functions of a sealing ring, but also the tasks of forming at least a part of a pre-seal in the form of a labyrinth seal and of providing an outer static seal with respect to first bearing part 32. Contact member 24 is advantageously made from sheet metal, as is carrier 39, and in addition to the known functions of a contact plate, performs a further sealing function in that it forms first collecting channel 22 in axial space 61.

The exemplary embodiments shown in the two figures may be used for both a rotating first bearing part 30, 32 and for a stationary first bearing part 30, 32. This means that the sealing assemblies according to the present invention may be used equally in wheel bearings for trucks and in those for passenger vehicles, regardless of whether the respective wheel bearing is designed to rotate externally or internally.

In summary, the present invention relates to a sealing assembly for sealing a rolling bearing, in particular a wheel bearing, between a first and a second bearing part, where the two bearing parts are rotatable relative to each other and form therebetween both an axial space and a radial space with respect to a common axis of rotation. The sealing assembly includes the following: A contact member having a preferably hollow-cylindrical mounting section for attachment and a ring-shaped contact section for positioning the contact member on the second bearing part, and a carrier which can be mounted to the first bearing part and has an elastic member forming a first axial sealing lip and/or a radial sealing lip. The teaching of the present invention demonstrates how service life and sealing performance may be increased in a cost-effective manner. It is proposed that the contact member and a radially extending portion of the second bearing part together form a first collecting channel, and that an opening leading into the first collecting channel should be at least partially defined by an end section of the contact member. It is thus possible to establish a labyrinth seal as a pre-seal which will contribute to the sealing effect without additional friction losses.

List of Reference Numerals

| | | | |
|---|---|---|---|
| 10 | cover member | 11 | sealing ring |
| 12 | first collecting channel | 13 | elastic member |
| 14 | contact member | 15 | second collecting channel |
| 16 | axial sealing lip | 17 | axial sealing lip |
| 18 | connecting member | 19 | radial sealing lip |
| 21 | sealing ring | 22 | first collecting channel |
| 23 | elastic member | | |
| 25 | non-sliding seal | 26 | extension |
| 27 | second collecting channel | 28 | radial end section |
| 29 | axial sealing lip | 30 | first bearing part |
| 31 | second bearing part | 32 | first bearing part |
| 34 | end section | 35 | ring-shaped intermediate section |
| 36 | radial sealing lip | 37 | mounting section |
| 38 | connecting section | 39 | carrier |
| 40 | mounting section | 41 | contact section |
| 43 | contact section | 44 | end section |
| 45 | carrier | 46 | anchor |
| 47 | mounting section | 48 | mounting section |
| 50 | opening | 51 | opening |
| 52 | hollow-cylindrical portion | 60 | radial space |
| 61 | axial space | | |

1-10. (canceled)

11. A sealing assembly for sealing a rolling bearing between a first and a second bearing part, the two bearing parts being rotatable relative to each other and forming therebetween both an axial space and a radial space with respect to a common axis of rotation, the sealing assembly comprising:
a contact member having a mounting section for attachment and a ring-shaped contact section for positioning the contact member on the second bearing part;
a carrier mountable to the first bearing part and having an elastic member forming at least one of a first axial sealing lip and a radial sealing lip;
the contact member defining, together with a radially extending portion of the second bearing part, a first collecting channel, an opening leading into the first collecting channel being at least partially defined by an end section of the contact member.

12. The sealing assembly as recited in claim 11 wherein at least one segment of the contact member forming the first collecting channel forms a part of a labyrinth seal.

13. The sealing assembly as recited in claim 11 wherein the mounting section is connected to the contact section by a connecting section.

14. The sealing assembly as recited in claim 13 wherein the connecting section is conical.

15. The sealing assembly as recited in claim 11 wherein the contact member radially encompasses the first bearing part, and the first bearing part forms a part of a labyrinth seal.

16. The sealing assembly as recited in claim 11 wherein the opening is formed by the end section and a cover member mountable on the first bearing part.

17. The sealing assembly as recited in claim 11 wherein the opening is defined in part by an extension of the elastic member.

18. The sealing assembly as recited in claim 17 wherein a sealing ring is formed on the elastic member, and the sealing ring provides a non-sliding seal for a mounting section of the carrier.

19. The sealing assembly as recited in claim 17 wherein a labyrinth seal is at least partially formed by the elastic member and the at least one segment of the contact member that forms the first collecting channel.

20. The sealing assembly as recited in claim 17 wherein the elastic member forms a second collecting channel extending radially inwardly from the first collecting channel.

21. The sealing assembly as recited in claim 20 wherein the extension partly covers the second collecting channel radially.

22. The sealing assembly as recited in claim 11 wherein the rolling bearing is a wheel bearing.

23. The sealing assembly as recited in claim 11 wherein the mounting section is a hollow-cylindrical mounting section.
